(19) United States
(12) Patent Application Publication
(10) Pub. No.: US 2014/0335260 A1
(43) Pub. Date: Nov. 13, 2014

(54) LIPID COMPOSITION

(71) Applicants: Adriana Fernanda Cruz, Bogota (CO); Camilo Medina, Bogota (CO)

(72) Inventors: Adriana Fernanda Cruz, Bogota (CO); Camilo Medina, Bogota (CO)

(21) Appl. No.: 13/893,014

(22) Filed: May 13, 2013

(51) Int. Cl. A23D 7/00

(52) U.S. Cl. CPC A23D 7/003
USPC 426/601

(57) ABSTRACT

A lipid composition having 90% or greater of a triglyceride mixture and 10% or less of a mixture comprising phospholipids and emulsifiers. Based on a total fatty acid content of the triglyceride mixture, the triglyceride mixture includes 95% or greater of C16-C22 fatty acid and 5% or less of C4-C14 fatty acid.

### COPYRIGHT NOTIFICATION

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### TECHNICAL FIELD

The present invention relates to lipid composition for use in food products.

### BACKGROUND OF THE INVENTION

Lipid compositions are known to be used in food products.

### SUMMARY OF THE INVENTION

In some embodiments, the lipid composition includes 90% or greater of a triglyceride mixture and 10% or less of a mixture including phospholipids and emulsifiers. In some embodiments, based on the total fatty acid content of the triglyceride mixture, the triglyceride mixture includes 95% or greater of C16-C22 fatty acid and 5% or less of C4-C14 fatty acid.

In some embodiments, the mixture comprising phospholipids and emulsifiers includes 5% or less phospholipids and 5% or less emulsifiers. In some embodiments, the lipid composition includes phospholipids that include soy lecithin and the emulsifiers include at least one of polysorbates, diacetyl tartaric esters, vegetable fatty acid esters and polyesters, ricinoleic acid esters and polyesters, lactic acid esters and polyesters, citric acid esters and polyesters, and acetic acid esters and polyesters.

In some embodiments, the lipid composition includes, based on the total fatty acid content of the triglyceride mixture, a triglyceride mixture with 15%-45% palmitic acid, 2%-15% stearic acid, and 35%-65% monosaturated fatty acids.

In some embodiments, the lipid composition includes a triglyceride mixture with polyunsaturated acids, and, based on the total fatty acid content of the triglyceride mixture, the triglyceride mixture includes 8-30% linoleic fatty acid and 6% or less linolenic fatty acid.

In some embodiments, the lipid composition includes monosaturated fatty acids that include oleic acid.

In some embodiments, the lipid composition, based on a total fatty acid content of the lipid composition, includes 20%-50% saturated fatty acids.

In some embodiments, the lipid composition, based on the total amount of fatty acids in the lipid composition, includes 1% or less trans-fatty acids.

In some embodiments, the lipid composition further includes a solid fat content at 20 degrees Celsius of 5% to 40%. In some embodiments, the solid fat content at 20 degrees Celsius is 10% to 30%. In some embodiments, the solid fat content at 20 degrees Celsius is 15% to 25%.

In some embodiments, the lipid composition further includes a solid fat content at 30 degrees Celsius of 1% to 20%. In some embodiments, the solid fat content at 30 degrees Celsius is 1% to 10%.

In some embodiments, the lipid composition further includes a solid fat content at 40 degrees Celsius of 0% to 10%. In some embodiments, the solid fat content at 40 degrees Celsius is 0% to 6%.

### BRIEF DESCRIPTION OF THE DRAWINGS

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

FIGS. 1A and 1B illustrate features of some embodiments of the present invention.

FIGS. 2A, 2B, and 2C illustrate features of some embodiments of the present invention.

FIGS. 3A and 3B illustrate features of some embodiments of the present invention.

FIGS. 4A and 4B illustrate features of some embodiments of the present invention.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DETAILED DESCRIPTION

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

Throughout the description, the following terms take the meanings explicitly associated herein, unless the context clearly dictates otherwise. The phrases “in one embodiment” and “in some embodiments” as used herein do not necessarily refer to the same embodiment(s), though they may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Physical properties defined hereinafter are measured at 20 to 25 degrees Celsius (° C.) unless otherwise specified.

As used herein, the term saturated fatty acids means a fatty acid without double bonds, the term unsaturated fatty acid means a fatty acid with at least one (monounsaturated) or more (polyunsaturated) double bonds, and the term trans-fat means a trans-isomer (E-isomer) of a fatty acid.

In some embodiments, the lipid composition of the present invention is used with food products including, but not limited to, cookies, breads, cakes, cookies, crackers, biscuits and/or other baked products. In an embodiment, the food products that include the lipid composition have similar properties including, but not limited to, texture, thickness, palatability, crunchiness, and/or appearance compared to food products that include traditional fats such as standard bakery fat or bakery shortening that thus have a higher fat content

In some embodiments, the food products that include the lipid composition of an embodiment of the present invention have a fat content up to 30% lower than the food products that include the traditional fats while maintaining similar properties including, but not limited to, texture, thickness, palatability, crunchiness, and/or appearance. In some embodiments, the food products that include the lipid composition of an embodiment of the present invention have a fat content up to 25% lower than the food products that include the traditional fats while maintaining similar properties. In some embodiments, the food products that include the lipid composition of an embodiment of the present invention have a fat content up to 20% lower than the food products that include the traditional fats while maintaining similar properties. In some embodiments, the food products that include the lipid composition of an embodiment of the present invention have a fat content up to 19% lower than the food products that include the traditional fats while maintaining similar properties. In some embodiments, the food products that include the lipid composition of an embodiment of the present invention have a fat content up to 15% lower than the food products that include the traditional fats while maintaining similar properties. In some embodiments, the food products that include the lipid composition of an embodiment of the present invention have a fat content up to 10% lower than the food products that include the traditional fats while maintaining similar properties. In some embodiments, the food products that include the lipid composition of an embodiment of the present invention have a fat content up to 5% lower than the food products that include the traditional fats while maintaining similar properties.

In one embodiment, the food products that include the lipid composition of the present invention include both unsaturated and saturated fatty acids and a content of trans-fat fatty acids low enough to be considered as a trans-fat free product under the U.S. Food and Drug Administration's (“FDA”) Definitions of Nutrient Content Claims. In one example, the food products that include the lipid composition of the present invention have 0.5 grams or less trans-fats per 100 grams of the lipid composition. In another example of the present invention, a trans-fatty acid content of the lipid composition is 2% or less based on a total amount of fatty acids in the lipid composition. In yet another example, a trans-fatty acid content of the lipid composition is 1% or less based on a total amount of fatty acids in the lipid composition.

In some embodiments, the lipid composition includes 90% or greater triglycerides. In some embodiments, the lipid composition includes 93% or greater triglycerides. In some embodiments, the lipid composition includes 96% or greater triglycerides. In some embodiments, the lipid composition includes 98% or greater triglycerides. In some embodiments, the lipid composition includes 99% or greater triglycerides.

In some embodiments, the triglycerides may include fatty acids and/or fatty acid esters. As used herein, “fatty acids” refers to fatty acids and fatty acid esters. In some embodiments, 95% or greater of the fatty acids have a carbon length of C16 to C22 and 5% or less of the fatty acids have a carbon length of C4 to C14. As used herein, the number after the “C” is the number of carbon atoms in the chain. Thus, a C4 fatty acid includes four carbon atoms. In some embodiments, 97% or greater of the fatty acids have carbon length of C16 to C22 and 3% or less of the fatty acids have a carbon length of C4 to C14. In some embodiments, 99% or greater of the fatty acids have carbon length of C16 to C22 and 1% or less of the fatty acids have a carbon length of C4 to C14.

In some embodiments, the triglycerides include 15% to 45% of a palmitic fatty acid C16:0. As used herein, the number after the colon details the number of double bonds in the carbon chain. Thus, a palmitic fatty acid C16:0 includes 16 carbon atoms with no double bonds between the carbon atoms. In some embodiments, the triglycerides include 20% to 45% of a palmitic fatty acid C16:0. In some embodiments, the triglycerides include 25% to 35% of a palmitic fatty acid C16:0. In some embodiments, the triglycerides include 15% to 30% of a palmitic fatty acid C16:0. In some embodiments, the triglycerides include 30% of a palmitic fatty acid C16:0.

In some embodiments, the triglycerides include 2% to 15% of a stearic fatty acid C18:0. In some embodiments, the triglycerides include 4% to 12% of a stearic fatty acid C18:0. In some embodiments, the triglycerides include 3% to 9% of a stearic fatty acid C18:0. In some embodiments, the triglycerides include 7% to 10% of a stearic fatty acid C18:0. In some embodiments, the triglycerides include 10% of a stearic fatty acid C 18:0. In some embodiments, the triglycerides include 5% of a stearic fatty acid C18:0.

In some embodiments, the triglycerides include 35% to 60% of monounsaturated fatty acids. In some embodiments, the triglycerides include 40% to 50% of monounsaturated fatty acids. In some embodiments, the triglycerides include 35% to 50% of monounsaturated fatty acids. In some embodiments, the triglycerides include 45% to 60% of monounsaturated fatty acids. In some embodiments, the triglycerides include 45% to 50% of monounsaturated fatty acids. In some embodiments, the triglycerides include 40% of monounsaturated fatty acids. In some embodiments, the triglycerides include 50% of monounsaturated fatty acids.

In some embodiments, the monounsaturated fatty acids include, but are not limited to, oleic acid C18:1.

In some embodiments, the triglycerides include 10% to 30% of polyunsaturated fatty acids. In some embodiments, the triglycerides include 15% to 20% of polyunsaturated fatty acids. In some embodiments, the triglycerides include 10% to 25% of polyunsaturated fatty acids. In some embodiments, the triglycerides include 10% of polyunsaturated fatty acids. In some embodiments, the triglycerides include 20% of polyunsaturated fatty acids. In some embodiments, the triglycerides include 15% of polyunsaturated fatty acids.

In some embodiments, the triglycerides include 8% to 30% of linoleic fatty acid C18:2. In some embodiments, the triglycerides include 10% to 25% of linoleic fatty acid C18:2. In some embodiments, the triglycerides include 15% to 30% of linoleic fatty acid C18:2. In some embodiments, the triglycerides include 10% to 20% of linoleic fatty acid C 18:2. In some embodiments, the triglycerides include 15% of linoleic fatty acid C18:2. In some embodiments, the triglycerides include 20% of linoleic fatty acid C 18:2.

In some embodiments, the triglycerides include 6% or less of linolenic fatty acid C18:3. In some embodiments, the triglycerides include 3% or less of linolenic fatty acid C18:3. In some embodiments, the triglycerides include 1% or less of linolenic fatty acid C18:3. In some embodiments, the triglycerides include 5% of linolenic fatty acid C18:3. In some embodiments, the triglycerides include 3% of linolenic fatty acid C18:3. In some embodiments, the triglycerides include 1% of linolenic fatty acid C18:3.

In some embodiments, the saturated fatty acids of the lipid composition range from 20% to 55%. In some embodiments, the saturated fatty acids of the lipid composition range from 30% to 50%. In some embodiments, the saturated fatty acids of the lipid composition range from 20% to 40%. In some embodiments, the saturated fatty acids of the lipid composition range from 25% to 45%. In some embodiments, the saturated fatty acids of the lipid composition range from 30% to 55%. In some embodiments, the saturated fatty acids of the lipid composition range from 20% to 52%. In some embodiments, the saturated fatty acids of the lipid composition are 48%. In some embodiments, the saturated fatty acids of the lipid composition range are 35%.

In some embodiments, the lipid composition includes 10% or less of a mixture of phospholipids and emulsifiers. In some embodiments, the lipid composition includes 8% or less of a mixture of phospholipids and emulsifiers. In some embodiments, the lipid composition includes 6% or less of a mixture of phospholipids and emulsifiers. In some embodiments, the lipid composition includes 3% or less of a mixture of phospholipids and emulsifiers. In some embodiments, the lipid composition includes 10% of a mixture of phospholipids and emulsifiers. In some embodiments, the lipid composition includes 5% of a mixture of phospholipids and emulsifiers. In some embodiments, the lipid composition includes 3% of a mixture of phospholipids and emulsifiers.

In some embodiments, the lipid composition includes 5% or less of phospholipids. In some embodiments, the lipid composition includes 3% or less of phospholipids. In some embodiments, the lipid composition includes 1% or less of phospholipids. In some embodiments, the lipid composition includes 5% of phospholipids. In some embodiments, the lipid composition includes 3% of phospholipids. In some embodiments, the lipid composition includes 1% of phospholipids.

In some embodiments, the phospholipids include soy lecithin, sunflower lecithin and ammonium phosphatide (also known as synthetic lecithine).

In some embodiments, the lipid composition includes 5% or less of emulsifiers. In some embodiments, the lipid composition includes 3% or less of emulsifiers. In some embodiments, the lipid composition includes 1% or less of emulsifiers. In some embodiments, the lipid composition includes 5% of emulsifiers. In some embodiments, the lipid composition includes 3% of emulsifiers. In some embodiments, the lipid composition includes 1% of emulsifiers.

In some embodiments, the emulsifiers include polysorbates, diacetyl tartaric esters, vegetable fatty acid esters and polyesters, ricinoleic acid esters and polyesters, lactic acid esters and polyesters, citric acid esters and polyesters, acetic acid esters and polyesters, and monoglycerides and diglycerides of fatty acids.

In some embodiments, the lipid composition includes 65% refined palm oil and 30% refined palm olein. In some embodiments, the lipid composition includes about 3% emulsifier such as Tween 80. In some embodiments, the lipid composition includes about 1% of soy lecithin.

In some embodiments, the lipid composition has a melting point of greater than 25 degrees Celsius. In some embodiments, the lipid composition has a melting point of 33 degrees Celsius.

In some embodiments, the lipid composition includes a solid fat content at 20 degrees Celsius (“N20”) ranges from 5 to 40%. The N values used herein refer to the percentage of fat which is solid or in the crystallized form at a given temperature. For example, an N20 equal to 16.5 indicates that 16.5% of the fat is in crystallized (solid) form at 20° C. In some embodiments, the lipid composition includes an N20 ranging from 7 to 20%. In some embodiments, the lipid composition includes an N20 ranging from 5 to 25%. In some embodiments, the lipid composition includes an N20 ranging from 10 to 30%. In some embodiments, the lipid composition includes an N20 ranging from 15 to 25%. In some embodiments, the lipid composition includes an N20 of 16%. In some embodiments, the lipid composition includes an N20 of 17%.

In some embodiments, the lipid composition includes an N30 ranging from 1% to 20%. In some embodiments, the lipid composition includes an N30 ranging from 1% to 10%. In some embodiments, the lipid composition includes an N30 ranging from 1% to 5%. In some embodiments, the lipid composition includes an N30 ranging from 5% to 10%. In some embodiments, the lipid composition includes an N30 is 4%.

In some embodiments, the lipid composition includes an N40 of ranging from 0% to 10%. In some embodiments, the lipid composition includes an N40 of ranging from 1% to 6%. In some embodiments, the lipid composition includes an N40 of ranging from 0% to 6%. In some embodiments, the lipid composition includes an N40 of ranging from 0% to 4%. In some embodiments, the lipid composition includes an N40 is 0%.

In some embodiments, the lipid composition includes 90% or greater of a triglyceride mixture and 10% or less of a mixture including phospholipids and emulsifiers. In some embodiments, based on the total fatty acid content of the triglyceride mixture, the triglyceride mixture includes 95% or greater of C16-C22 fatty acid and 5% or less of C4-C14 fatty acid.

In some embodiments, the mixture comprising phospholipids and emulsifiers includes 5% or less phospholipids and 5% or less emulsifiers. In some embodiments, the lipid composition includes phospholipids that include soy lecithin and the emulsifiers include at least one of polysorbates, diacetyl tartaric esters, vegetable fatty acid esters and polyesters, ricinoleic acid esters and polyesters, lactic acid esters and polyesters, citric acid esters and polyesters, and acetic acid esters and polyesters.

In some embodiments, the lipid composition includes, based on the total fatty acid content of the triglyceride mixture, a triglyceride mixture with 15%-45% palmitic acid, 2%-15% stearic acid, and 35%-65% monosaturated fatty acids.

In some embodiments, the lipid composition includes a triglyceride mixture with polyunsaturated acids, and, based on the total fatty acid content of the triglyceride mixture, the triglyceride mixture includes 8-30% linoleic fatty acid and 6% or less linolenic fatty acid. In some embodiments, the lipid composition includes a triglyceride mixture with polyunsaturated acids, and, based on the total fatty acid content of the triglyceride mixture, the triglyceride mixture includes 15-30% linoleic fatty acid and 3% or less linolenic fatty acid. In some embodiments, the lipid composition includes a triglyceride mixture with polyunsaturated acids, and, based on the total fatty acid content of the triglyceride mixture, the triglyceride mixture includes 10-20% linoleic fatty acid and 5% or less linolenic fatty acid.

In some embodiments, the lipid composition includes monosaturated fatty acids that include oleic acid.

In some embodiments, the lipid composition, based on a total fatty acid content of the lipid composition, includes 20%-55% saturated fatty acids. In some embodiments, the lipid composition, based on a total fatty acid content of the lipid composition, includes 20%-52% saturated fatty acids.

In some embodiments, the lipid composition, based on the total amount of fatty acids in the lipid composition, includes 1% or less trans-fatty acids.

### Lipid Composition in Rotary Cookie

### Example 1

In a non-limiting example, a rotary cookie with a traditional formulation (“a traditional rotary cookie”) that includes standard bakery shortening was compared to a rotary cookie with the lipid composition of an embodiment of the present invention (“a lipid composition rotary cookie”). The lipid composition rotary cookie included 10.15% fat compared with 12% fat in the traditional rotary cookie. Additional water and cookie wheat were added to the lipid composition rotary cookie to compensate for the reduced fat content. Each uncooked rotary cookie was 0.5 centimeters in height and formed in a flower shape.

The formulation of the traditional rotary cookie of Example 1 is detailed in the following table.

TABLE 1
Example 1: Traditional Rotary Cookie Formulation

| | % in the |
|---|---|
| Ingredient | formulation |
| Cookie wheat | 50.4 |
| Corn starch | 8.3 |
| Sugar | 15.7 |
| Glucose | 4.5 |
| Standard Fat | 12.5 |
| Non-fat powder milk | 1.2 |
| Salt | 0.4 |
| Sodium bicarbonate | 0.2 |
| Ammonia bicarbonate | 0.1 |
| Water | 6.7 |

The formulation of the lipid composition rotary cookie of Example 1 is detailed in the following table.

TABLE 2
Example 1: Lipid Composition Rotary Cookie Formulation

| | % in the |
|---|---|
| Ingredient | formulation |
| Cookie wheat | 51.58 |
| Corn starch | 8.3 |
| Sugar | 15.7 |
| Glucose | 4.5 |
| Lipid Composition | 10.15 |
| Non-fat powder milk | 1.2 |
| Salt | 0.4 |
| Sodium bicarbonate | 0.2 |
| Ammonia bicarbonate | 0.1 |
| Water | 7.88 |

The lipid composition of an embodiment of the present invention used in the lipid composition rotary cookies of Example 1 includes the following components:

TABLE 3
Example 1: Lipid Composition of an
Embodiment of the Present Invention

| | % in the |
|---|---|
| Ingredient | formulation |
| Refined Palm Oil | 65.85 |
| Refined Palm Olein | 30.00 |
| Tween 80 | 2.75 |
| Soy Lecithin | 1.40 |

The lipid composition of an embodiment of the present invention used in the lipid composition rotary cookies of Example 1 has the following properties:

TABLE 4
Example 1: Lipid Composition of an
Embodiment of the Present Invention

| Property | Value |
|---|---|
| Melting Point (° C.) | 33 |
| Solid Fat Content (%) | |
| N20 (%) | 16.5 |
| N30 (%) | 4.0 |
| N40 (%) | 0 |
| Saturated fatty acid (%) | 48 |

A comparison of the saturated fatty acids and calories from fat of each rotary cookie is included in the following table.

TABLE 5
Example 1: Comparison of Saturated Fatty Acids and Fat Calories

| | | Lipid | |
|---|---|---|---|
| | Traditional | Composition | % |
| Property | Rotary Cookie | Rotary Cookie | Reduction |
| Saturated fatty acids | 6 | 4.87 | 19 |
| (grams) | | | |
| Calories from fat | 112.5 | 91.3 | 19 |

The ingredients of each cookie of Example 1 were mixed at a temperature of 22° C. to 25° C. for 3 minutes and baked at an oven temperature of 180° C. for 8 minutes.

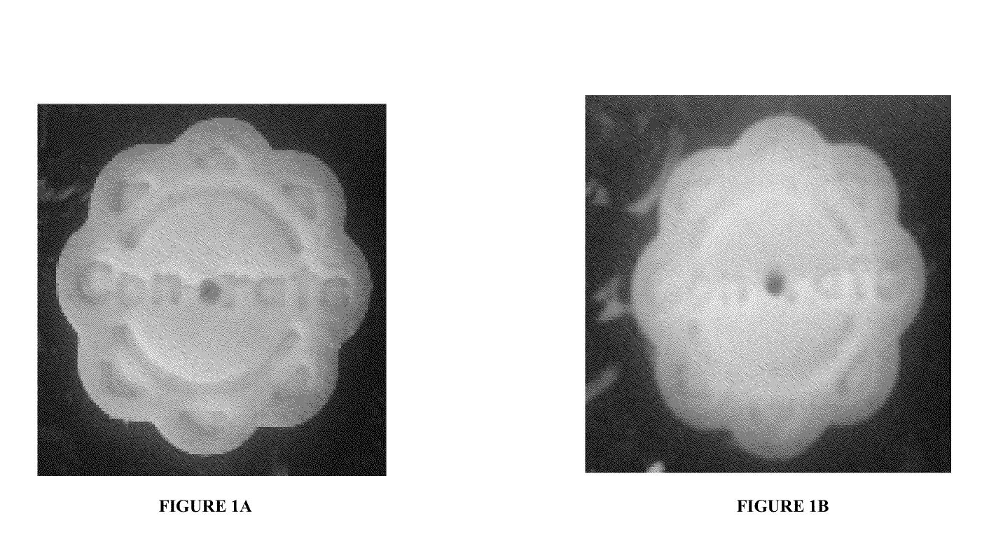

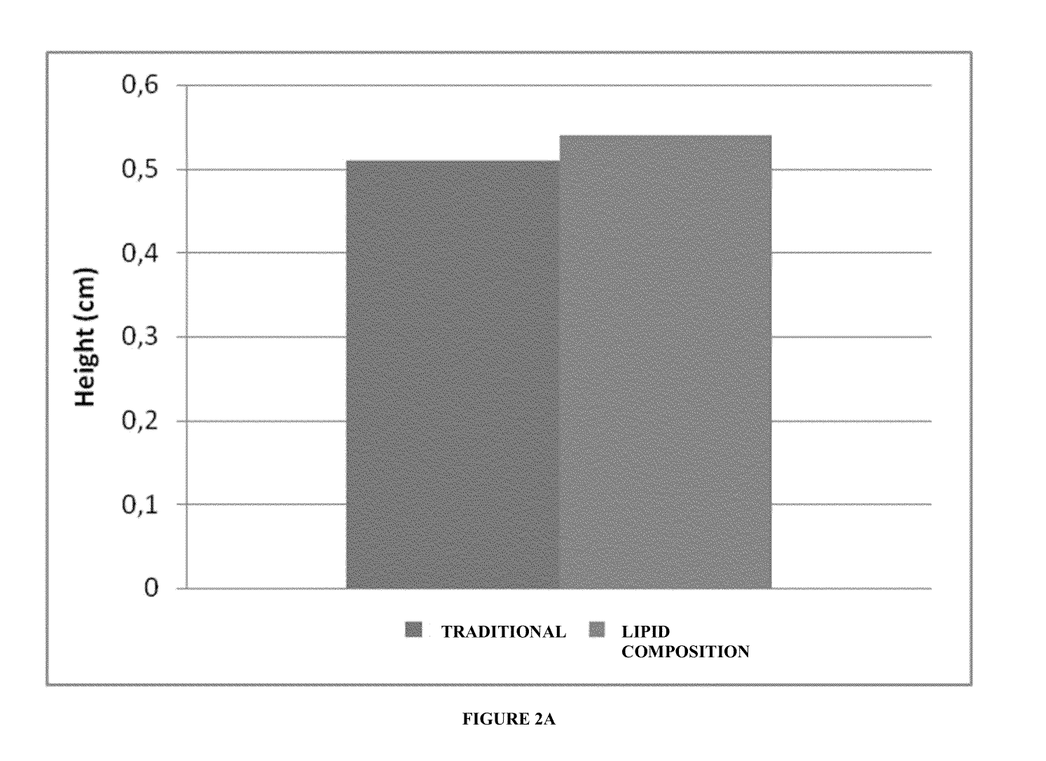

A traditional rotary cookie of Example 1 is shown in FIG. 1A. A lipid composition rotary cookie of Example 1 is shown in FIG. 1B.

After baking, the rotary cookies were evaluated for the qualitative properties such as crunch, flavor, surface smoothness, surface cracking, crumbs size, and/or color. Qualitative analysis shows that the traditional rotary cookies and the lipid composition rotary cookies both present a smooth and homogeneous surface with characteristic cracking and without a dry appearance. Further, the rotary cookies both exhibited very similar homogeneous crunch and color. The sugar flavor of the lipid composition rotary cookies was slightly less intense than the sugar flavor of the traditional rotary cookies.

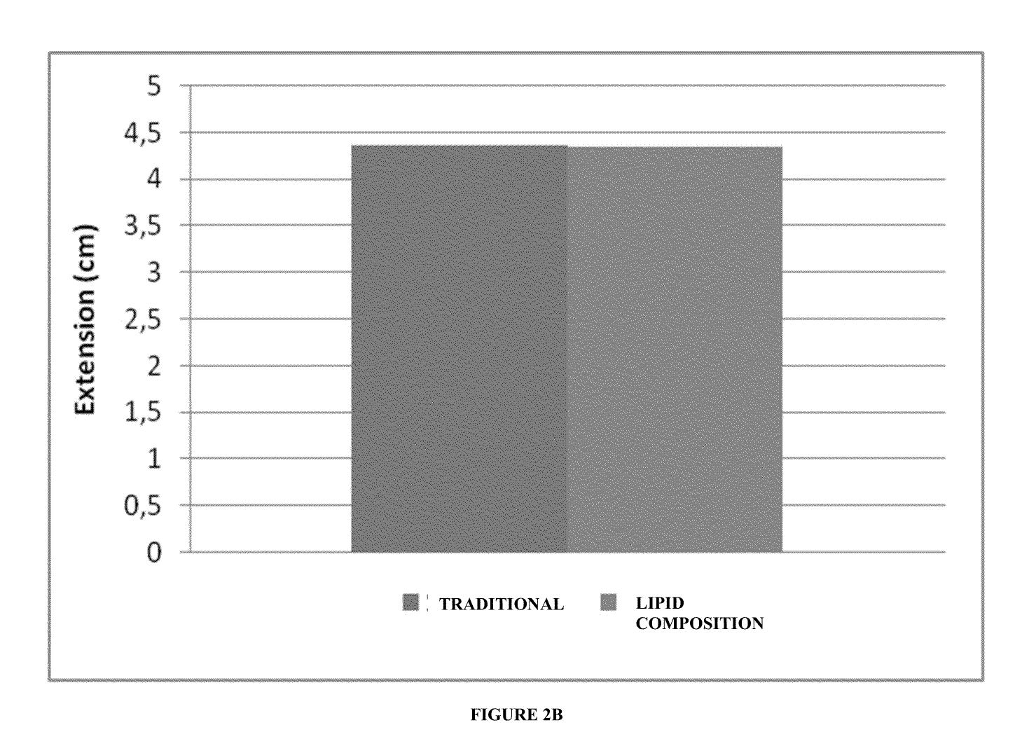

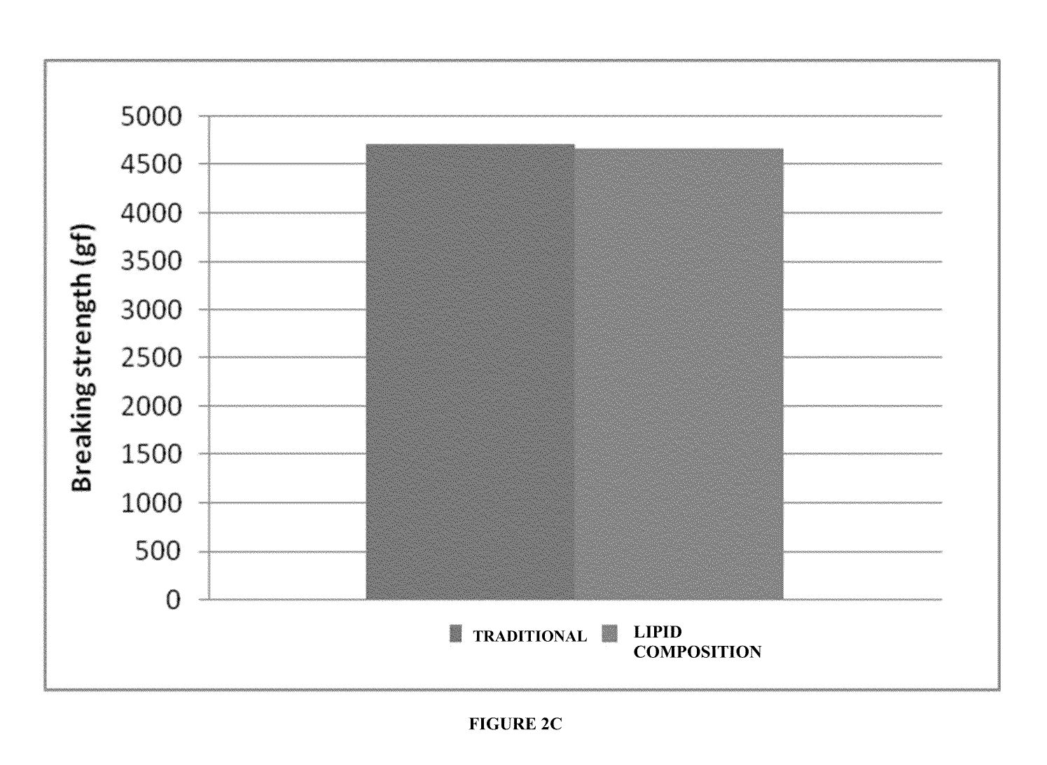

The rotary cookies were also measured for height after baking, extension after baking, and breaking strength. As used herein, extension is a measurement of the diameter of the cookie after baking using a vernier scale. The breaking strength was measured with a Stable Micro Systems TA.XT Plus 11163 texturometer using the method BISCUIT BIS4 3P8 as defined by the manufacturer. The results of the testing are shown in FIGS. 2A, 2B and 2C.

As illustrated by FIGS. 2A, 2B, and 2C, the traditional rotary cookies and the lipid composition rotary cookies exhibited similar height, extension and the breaking strength.

### Lipid Composition in Wire Cut Cookie

### Example 2

In a non-limiting example, a wire cut cookie with a traditional formulation (“a traditional wire cut cookie”) that includes standard bakery fat was compared to a wire cut cookie with the lipid composition of an embodiment of the present invention (“a lipid composition wire cut cookie”). The lipid composition wire cut cookie included 16.63% fat compared with 20.5% fat in the traditional wire cut cookie. Additional water and cookie wheat were added to the lipid composition wire cut cookie to compensate for the reduced fat content. Each uncooked wire cut cookie was 4 centimeters in diameter and 0.5 centimeters in height.

The formulation of the traditional wire cut cookie of Example 2 is detailed in the following table.

TABLE 6
Example 2: Traditional Wire Cut Cookie Formulation

| | % in the |
|---|---|
| Ingredient | formulation |
| Cookie wheat | 45.5 |
| Sugar | 22.7 |
| Standard Fat | 20.5 |
| Non-fat powder milk | 2.2 |
| Salt | 0.45 |
| Sodium bicarbonate | 0.36 |
| Baking powder | 0.45 |
| Water | 7.73 |

The formulation of the lipid composition wire cut cookie of Example 2 is detailed in the following table.

TABLE 7
Example 2: Lipid Composition Wire cut Cookie Formulation

| | % in the |
|---|---|
| Ingredient | formulation |
| Cookie wheat | 47.4 |
| Sugar | 22.7 |
| Lipid Composition | 16.63 |
| Non-fat powder milk | 2.3 |
| Salt | 0.45 |
| Sodium bicarbonate | 0.36 |
| Baking powder | 0.45 |
| Water | 9.66 |

The lipid composition of an embodiment of the present invention used in the lipid composition wire cut cookies of Example 2 includes the following components:

TABLE 8
Example 2: Lipid Composition of an
Embodiment of the Present Invention

| | % in the |
|---|---|
| Ingredient | formulation |
| Refined Palm Oil | 65.85 |
| Refined Palm Olein | 30.00 |
| Tween 80 | 2.75 |
| Soy Lecithin | 1.40 |

The lipid composition of an embodiment of the present invention used in the lipid composition wire cut cookies of Example 2 has the following properties:

TABLE 9
Example 2: Lipid Composition of an
Embodiment of the Present Invention

| Property | Value |
|---|---|
| Melting Point (° C.) | 33 |
| Solid Fat Content (%) | |
| N20 (%) | 16.5 |
| N30 (%) | 4.0 |
| N40 (%) | 0 |
| Saturated fatty acid (%) | 48 |

A comparison of the saturated fatty acids and calories from fat of each wire cut cookie is included in the following table.

TABLE 10
Example 2: Comparison of Saturated Fatty Acids and Fat Calories

| | | Lipid | |
|---|---|---|---|
| | Traditional | Composition | % |
| Property | Wire cut Cookie | Wire cut Cookie | Reduction |
| Saturated fatty acids | 9.8 | 7.7 | 19 |
| (grams) | | | |
| Calories from fat | 184.5 | 149.6 | 19 |

The ingredients of each cookie of Example 2 were mixed at a temperature of 22° C. to 25° C. for 3 minutes and baked at an oven temperature of 180° C. for 8 minutes.

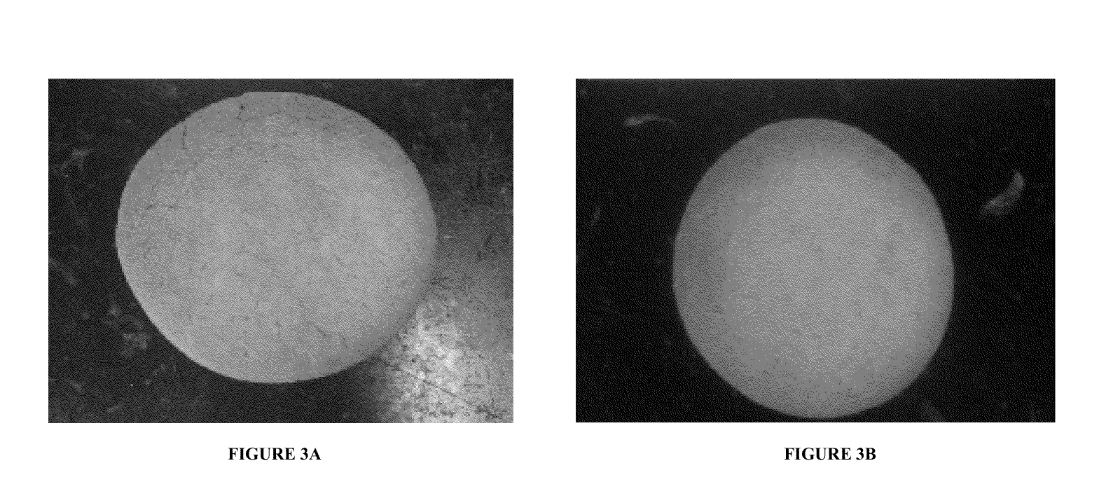

A traditional wire cut cookie of Example 2 is shown in FIG. 3A. A lipid composition wire cut cookie of Example 2 is shown in FIG. 3B.

After baking, the wire cut cookies were evaluated for the qualitative properties such as crunch, flavor, surface smoothness, surface cracking, crumbs size, and/or color. Qualitative analysis shows that the traditional wire cut cookies and the lipid composition wire cut cookies both present a smooth and homogeneous surface. The wire cut cookies both exhibited very similar homogeneous crunch and color. The lipid composition wire cut cookie was rated with good texture, softness and without dryness on the palate similar to the rating of the traditional wire cut cookie.

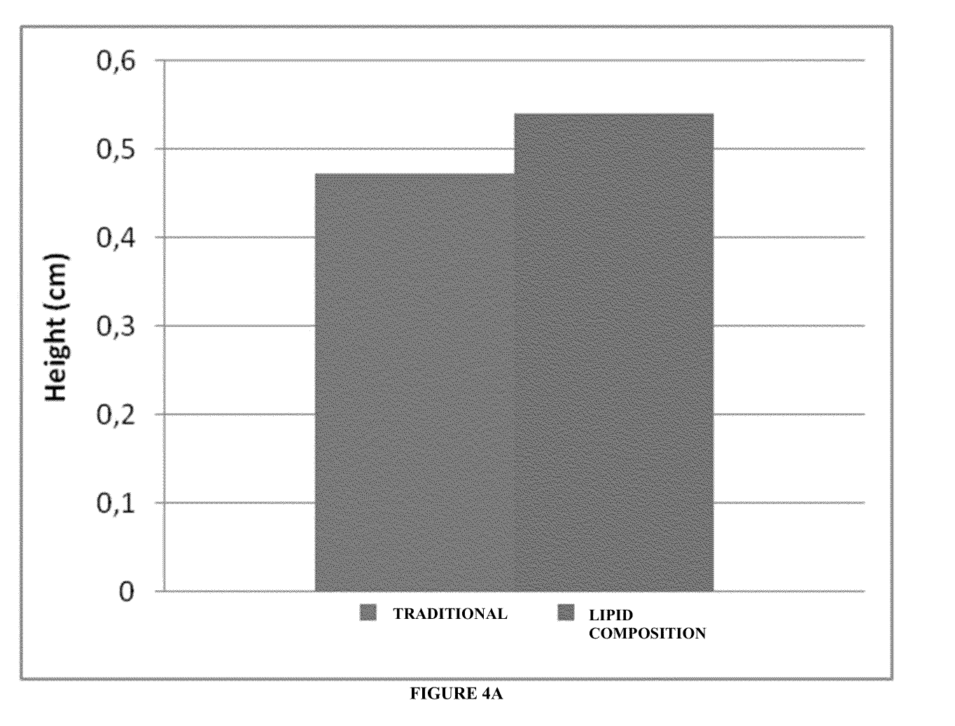

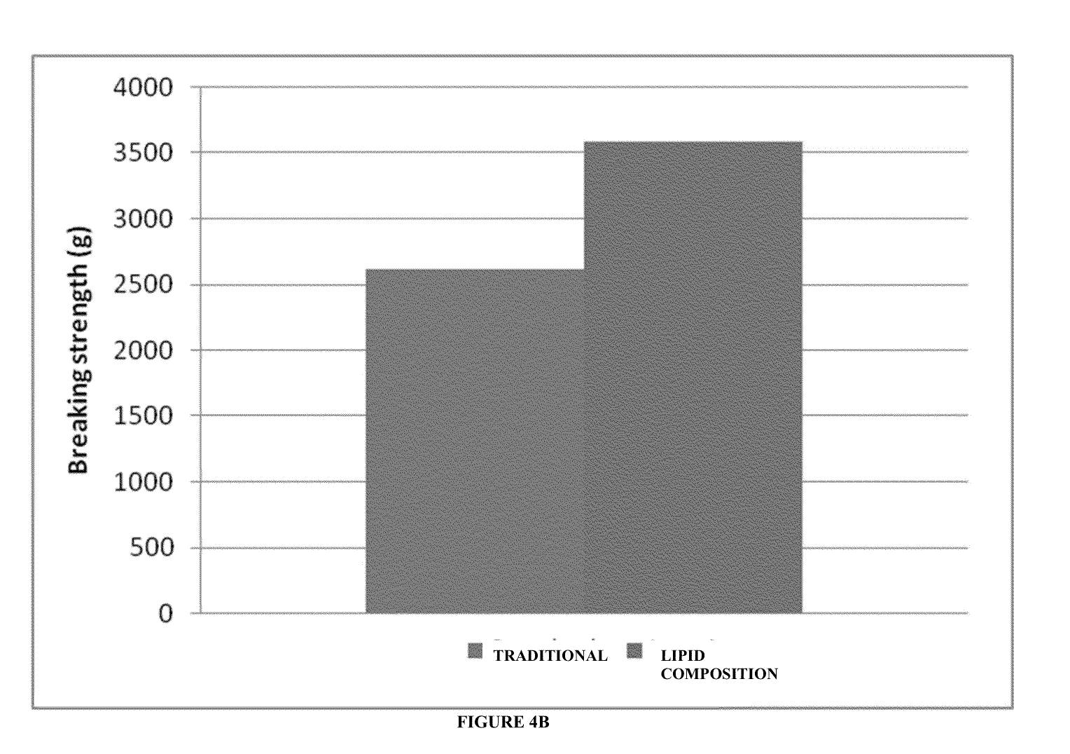

The wire cut cookies were also measured for height after baking and breaking strength. The breaking strength was measured with a Stable Micro Systems TA.XT Plus 11163 texturometer using the method BISCUIT BIS4 3P8 as defined by the manufacturer. The results of the testing are shown in FIGS. 4A and 4B.

As illustrated by FIGS. 4A and 4B, the traditional wire cut cookies and the lipid composition wire cut cookies exhibited similar height and the breaking strength.

Although a few embodiments of the present invention have been shown and described, it will be appreciated by those skilled in the art that changes may be made in these embodiments without departing from the principles and spirit of the present invention, the scope of which is defined in the appended claims and their equivalents.

What is claimed is:

1. A lipid composition, comprising:
90% or greater of a triglyceride mixture; and
10% or less of a mixture comprising phospholipids and emulsifiers,
wherein, based on a total fatty acid content of the triglyceride mixture, the triglyceride mixture comprises:
95% or greater of C16-C22 fatty acid, and
5% or less of C4-C14 fatty acid.

2. The lipid composition of claim 1, wherein the mixture comprising phospholipids and emulsifiers comprises:
5% or less phospholipids, and
5% or less emulsifiers.

3. The lipid composition of claim 1, wherein:
the phospholipids comprise at least one of soy lecithin, sunflower lecithin and ammonium phosphatide and
the emulsifiers comprise at least one of polysorbates, diacetyl tartaric esters, vegetable fatty acid esters and polyesters, ricinoleic acid esters and polyesters, lactic acid esters and polyesters, citric acid esters and polyesters, acetic acid esters and polyesters, and monoglycerides and diglycerides of fatty acids.

4. The lipid composition of claim 3, wherein, based on the total fatty acid content of the triglyceride mixture, the triglyceride mixture comprises:
15%-45% palmitic acid,
2%-15% stearic acid, and
35%-65% monosaturated fatty acids.

5. The lipid composition of claim 4, wherein the triglyceride mixture comprises polyunsaturated acids, and wherein, based on the total fatty acid content of the triglyceride mixture, the triglyceride mixture comprises:
8-30% linoleic fatty acid, and
6% or less linolenic fatty acid.

6. The lipid composition of claim 5, wherein the monosaturated fatty acids comprises oleic acid.

7. The lipid composition of claim 6, wherein, based on a total fatty acid content of the lipid composition, the lipid composition comprises 20%-52% saturated fatty acids.

8. The lipid composition of claim 1, wherein, based on the total amount of fatty acids in the lipid composition, the lipid composition comprises 1% or less trans-fatty acids.

9. The lipid composition of claim 1, wherein the lipid composition further comprises a solid fat content at 20 degrees Celsius of 5% to 40%.

10. The lipid composition of claim 9, wherein the solid fat content at 20 degrees Celsius is 10% to 30%.

11. The lipid composition of claim 10, wherein the solid fat content at 20 degrees Celsius is 15% to 25%.

12. The lipid composition of claim 1, wherein the lipid composition further comprises a solid fat content at 30 degrees Celsius of 1% to 20%.

13. The lipid composition of claim 12, wherein the solid fat content at 30 degrees Celsius is 1% to 10%.

14. The lipid composition of claim 1, wherein the lipid composition further comprises a solid fat content at 40 degrees Celsius of 0% to 10%.

15. The lipid composition of claim 14, wherein the solid fat content at 40 degrees Celsius is 0% to 6%.
